(19) United States
(12) Patent Application Publication
(10) Pub. No.: US 2024/0086448 A1
(43) Pub. Date: Mar. 14, 2024

(54) DETECTING CITED WITH CONNECTIONS IN LEGAL DOCUMENTS AND GENERATING RECORDS OF SAME

(71) Applicant: Thomson Reuters Enterprise Centre GmbH, Zug (CH)

(72) Inventors: Sharon Ruth Stanley, Minneapolis, MN (US); Shelly Albaum, Sebastopol, CA (US); John Michael Engelhart, Minneapolis, MN (US); Steven R. Sidwell, Richfield, MN (US)

(21) Appl. No.: 18/465,971

(22) Filed: Sep. 12, 2023

Related U.S. Application Data
(60) Provisional application No. 63/405,674, filed on Sep. 12, 2022.

(51) Int. Cl. G06F 16/38; G06F 16/332; G06F 16/335; G06F 40/194

(52) U.S. Cl. CPC G06F 16/38; G06F 16/3325; G06F 16/335; G06F 40/194

(57) ABSTRACT

Embodiments of the present disclosure support systems and methods providing functionality for detecting the presence of cited with relationships in documents. In an aspect, a plurality of documents comprising legal citations is received and analyzed by one or more processors to detect cited with relationships within the documents. The plurality of documents may be analyzed to identify subsets of documents based on the legal citations and the cited with relationships. The cited with relationships may be identified and/or classified according to sets of proximity and/or contextual rules. In an aspect, metadata related to the cited with relationships may be generated and stored in a metadata database. In an aspect, metadata regarding cited with relationship may facilitate searching for documents having and/or identifying cited with relationships.

The present application claims the benefit of and priority to U.S. Provisional Application No. 63/405,674, filed Sep. 12, 2022, and entitled “SYSTEMS AND METHODS FOR IDENTIFYING CITED WITH CONTENT”, the content of which is incorporated herein by reference in its entirety.

### TECHNICAL FIELD

The present disclosure relates to generally to textual analytics, and more particularly to artificial intelligence-based detection of related textual content.

### BACKGROUND

Many documents rely on the content of other documents when making assertions or providing conclusions. For example, in a first legal case treating a legal issue or point of law, the legal case may rely on a decision or treatment of the issue in a second case. In this sense, the first case may cite to the second case. Many other cases may also cite to the second case. When this occurs, it may be easy for a searcher to find both the first and second cases for review or analysis. However, related cases may not always cite each other. Instead, cases that do not cite each other may be cited together in a third case. Cases that are cited together tend to be related in some important ways for researchers. If a researcher finds one document useful, they may want to know about the other.

Detecting legal documents that present connections between other legal documents is a challenging technical problem. The vast number of legal documents produced on a daily basis makes human review of the documents for cited with connections and relationships highly impractical. For example, there can be over 6,000 new documents acquired on a given day. Compounded with the numerous internal references and legal citations typical for legal documents, human review for each of the connections made by citations in legal documents would be practically impossible to perform manually, much less do so in a timely manner. Even cataloging for direct connections alone would take thousands of hours of review every day. Human review is further made impossible considering the need to update existing databases—frequently containing millions of documents—on a daily basis based on changes in the law, updates on cases, and new connections formed and identified in newly acquired documents.

The form of legal documents also presents problems for computers to accurately determine cited with relationships for legal citations. For example, legal documents may vary from one another as a result of a nuances in the law, differences in the substance of the law, differences in sources of law applied during a case, differences in legal procedure, jurisdictional differences, differences between the underlying facts of a case, writing style, typographical errors, writing skill, and/or a writer's familiarity with the law. Each of these factors can create a different set of challenges in developing rulesets to identify and classify the relationships between documents, particularly in identifying indirect connections between documents. For example, connections and relationships between some legal documents may only be established when the documents are cited with each other in a separate document.

Legal researchers may nonetheless desire to quickly search for the most up-to-date cases by how they have been cited with other cases.

### SUMMARY

Embodiments of the present disclosure provide systems, methods, and computer-readable storage media supporting operations to detect, classify, and generate particular features within a set of documents. In particular, embodiments of the present disclosure may be configured to detect the presence of two or more legal citations in a given document having a cited with relationship with one another. According to aspects of the present disclosure, the above-mentioned systems, methods, and computer-readable storage media may also be configured to run searches on databases for documents containing legal citations having a cited with relationship. Detecting cited with relationships provides several benefits to researchers, legal writers and others. For example, being able to identify cited with relationships may enable researchers to more quickly identify relationships between legal documents. Cited with relationships may also enable researchers to more quickly and/or more thoroughly understand certain legal issues, such as, for example, circuit splits, comparative points of law, and/or nuances within point of law. Methods of detecting, classifying, and searching for citations having a cited with relationship such as described herein thus promote efficient and effective researching. As discussed above, the vast number of legal documents cannot reasonably be parsed by a human researcher without consuming large amounts of time. Therefore, systems, methods, and computer-readable storage media configured to detect and make known the existence of cited with relationships provide a significant benefit.

The disclosed feature generation techniques may include receiving a plurality of documents. Each document of the plurality of documents may include legal citations. The disclosed techniques may include detecting legal citations within a given document of the plurality of documents, analyzing each of the plurality of documents to detect a subset of documents in the plurality of documents, determining a proximity metric for each document of the subset of documents based on a set of proximity rules, and pruning the subset of documents based on the proximity metrics and a set of contextual rules to produce a reduced set of documents. The reduced set of documents may include or correspond to a portion of the subset of documents in which the legal citations have a cited with relationship. The disclosed techniques may include generating one or more records in a metadata database. Each of the one or more records generated may include metadata. For records including metadata, the metadata may identify at least one document within the reduced set of documents including legal citations having a cited with relationship within the at least one document.

In some aspects, detecting, classifying, and generating records of cited with relationships may enable the later searching for cited with relationships in connection with other documents. For example, disclosed herein are techniques for receiving, by one or more processors, search parameters via inputs to a graphical user interface (GUI), executing, by the one or more processors, a search of a document database based on the search parameters to identify a set of search results, and outputting, by the one or more processors, the set of search results to the GUI. In some aspects, each search result of the set of search results may include or correspond to a particular document of a plurality of documents associated with the document database. In some aspects, the GUI may include one or more selectable elements for viewing the documents corresponding to set of search results.

The techniques disclosed herein support operations including receiving, by the one or more processors, a first input corresponding to selection of a first selected element of the one or more selectable elements, and displaying, based on the first input, a document corresponding to the particular search result. The first selected element may include or correspond to a particular search result of the set of search results. Operations using the techniques disclosed herein may further include initiating, by the one or more processors, a second search based on a second input received during display of the document corresponding to the particular search result. The second search may include querying a metadata database to identify additional search results. The additional search results may include or correspond to other documents of the plurality of documents that identify a cited with relationship with respect to the document corresponding to the particular search result and an additional document of the plurality of documents. And the techniques disclosed herein support operations including outputting, by the one or more processors, the additional search results to the GUI.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following descriptions taken in conjunction with the accompanying drawings, in which:

FIG. 1 shows a block diagram of a feature generation system in accordance with aspects of the present disclosure;

FIG. 2 shows a block diagram illustrating an exemplary plurality of documents in accordance with aspects of the present disclosure;

FIG. 3 illustrates an exemplary graphical user interface for displaying information associated with search results obtained in accordance with aspects of the present disclosure;

FIG. 4A illustrates an exemplary graphical user interface for displaying information associated with search results obtained in accordance with aspects of the present disclosure;

FIG. 4B illustrates an exemplary graphical user interface for displaying information associated with search results obtained in accordance with aspects of the present disclosure;

FIG. 5 is a flow diagram of an exemplary method for detecting a cited with relationship in accordance with aspects of the present disclosure; and

FIG. 6 is a flow diagram of an exemplary method for searching for cited with relationships in accordance with aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

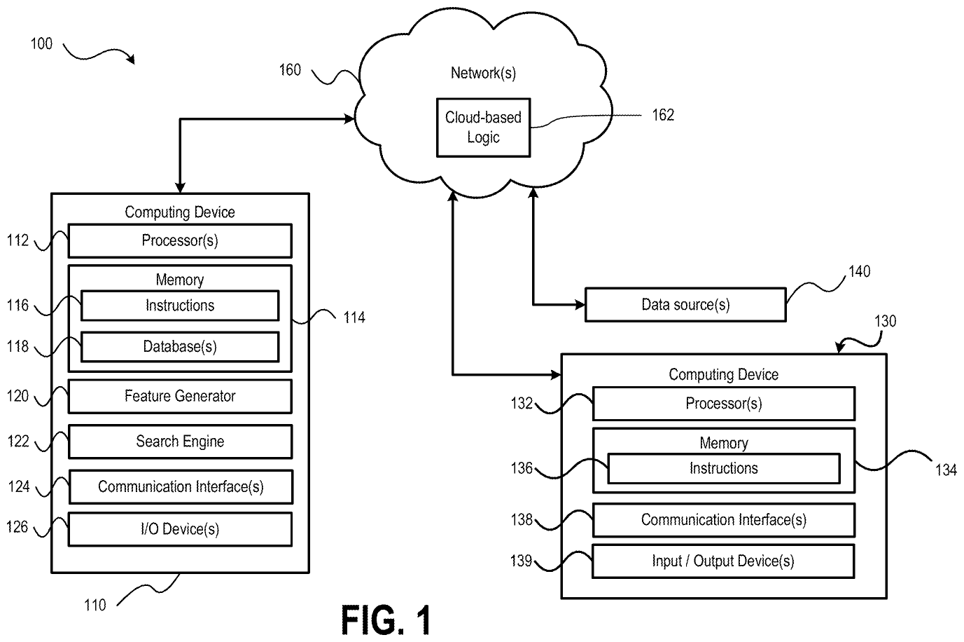

Referring to FIG. 1, a block diagram of a feature generation system in accordance with aspects of the present disclosure is shown as a system 100. As described in more detail below, the system 100 is configured to receive a plurality of documents containing legal citations and detect documents from within the plurality of documents including citations having a cited with relationship with respect to each other and generate records identifying the documents having the cited with relationship. In an aspect, the system 100 may also provide functionality for searching databases or other data sources for documents containing a cited with relationship. Exemplary details regarding the above-identified functionality of the system 100 are described in more detail below.

As illustrated in FIG. 1, the system 100 includes a computing device 110. The computing device 110 may be configured to detect cited with relationships within documents. While shown as computing device 110, the same or similar functionality may be provided by other implementations, such as through cloud based logic 162, through a distributed computing system, or other computing methods. As shown in FIG. 1, the computing device 110 may include one or more processors 112, a memory 114, a feature generator 120, a search engine 122, one or more communication interfaces 124, and input/output (I/O) devices 126. The one or more processors 112 may include a central processing unit (CPU), graphics processing unit (GPU), a microprocessor, a controller, a microcontroller, a plurality of microprocessors, an application-specific integrated circuit (ASIC), an application-specific standard product (ASSP), or any combination thereof. The memory 114 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. The memory 114 may also store instructions 116 that, when executed by the one or more processors 112, cause the one or more processors 112 to perform operations described herein with respect to the functionality of the computing device 110 and the system 100. The memory 114 may further include one or more databases 118, which may store data associated with operations described herein with respect to the functionality of the computing device 110 and the system 100.

The communication interface(s) 124 may be configured to communicatively couple the computing device 110 to the one or more networks 160 via wired or wireless communication links according to one or more communication protocols or standards. The I/O devices 126 may include one or more display devices, a keyboard, a stylus, a scanner, one or more touchscreens, a mouse, a trackpad, a camera, one or more speakers, haptic feedback devices, or other types of devices that enable a user to receive information from or provide information to the computing device 110.

The one or more databases 118 may be configured to store a plurality of documents. As a non-limiting and illustrative example, the plurality of documents may include legal documents, such as case law documents, (e.g., decisions from courts of various geographical or subject matter jurisdictions, and/or decisions from courts from various legal hierarchies within a given jurisdiction), statutes, legal codes, legal briefs, legal motions, journal articles, and/or treatises. The plurality of documents may also include other kinds of documents including contracts, practice forms, subject matter guides, news articles, webpages, forum discussions, books, and the like. Each document of the plurality of documents may include legal citations (e.g., references and/or citations to another document). Legal citations may include, as non-limiting examples, a reference to a source of law, (e.g., a statute, court case decision, administrative rules, the results of a proceeding, a legislative history, and so on), a reference to a binding source of law (e.g., a statute applicable in a particular jurisdiction and/or a precedential court case), a reference to an analogous source of law, a reference to a comparative source of law, a reference to a contradictory point of law, a reference to a scholarly article (e.g., a journal article, a collection of cases, a legal commentary, or a treatise), a reference to another legal document (for example, a brief, a motion, an administrative filing, or the like), or any combination thereof.

The feature generator 120 may be configured to generate records of cited with relationships in legal documents. For example, the feature generator 120 may be configured to detect the presence of a cited with relationship among legal citations in a given document, classify the cited with relationship, and/or generate a record of the cited with relationship such that the cited relationship may be found during subsequent searching.

A cited with relationship may include the relationship between a first legal citation and a second legal citation included in the same document. For example, a given document may include a first legal citation and a second legal citation. In some instances the first legal citation and the second legal citation may be cited for different points of law. In other instances, the first legal citation may correspond to a point of law (e.g., a legal principle and/or legal rule) identified in a source of law (e.g., a court case decision or a statute) and the second legal citation may correspond to a source of law that also corresponds to the point of law corresponding to the first legal citation. The second legal citation may correspond to a point of law that supports the point of law corresponding to the first legal citation, the second legal citation may correspond to a point of law that contradicts the point of law corresponding to the first legal citation, or second legal citation may correspond to a point of law similar to or dissimilar to the point of law corresponding to the first legal citation to draw a comparison between the two points of law. To illustrate, a first legal citation to a statute may be cited with a second legal citation to a court case decision applying the statute. As another example, a first legal citation may include or correspond to a court case decision (e.g., a precedential court case) and may be cited with a second legal citation may correspond to another court case decision applying the same principle of law (e.g., a case with a similar set of facts in the same jurisdiction, applying the same principles, and resulting in a similar outcome). In another example, a first legal citation to a case in one jurisdiction may be cited for one point of law, and a second legal citation to a case in a different jurisdiction corresponding to a contradictory point of law may be cited for contrast.

In some instances, the second legal citation may include or correspond to a source of law that provides a comparative and/or analogous point of law to the first legal citation. This can include, for example, a citation to case applying a point of law different from the point of law corresponding to the first legal citation, but in support of a similar outcome. Another example is that a point of law may be applied differently in one state or country than in a different state or country, and the first and second legal citations may emphasize the differences for comparison's sake.

In some instances, the second legal citation may correspond to a source of law that contradicts the point of law. For example, the same point of law may be applied in contradictory manners in different geographical areas (e.g., in a circuit split). Other examples of contradictory cited with relationships may include citations to overruled cases, or citations in dissenting opinions.

In some instances, a cited with relationship between two or more legal citations in a document may be present when the legal citations are located near each other in the document. For example, a cited with relationship may be determined based on proximity metrics. But in other instances, a cited with relationship may depend on more than proximity within a document, and the context of each legal citation with respect to other citations may need to be evaluated to determine if a cited with relationship exists. Techniques for determining the presence of a cited with relationship based on proximity and/or context are discussed below.

These examples of the varying circumstances under which a legal citation may be said to be cited with another legal citation in the same document highlight the technical difficulty in detecting and classifying cited with relationships. Rules for determining cited with relationships may be complex and nuanced in order to guide a computing device (such as computing device 110 in FIG. 1) to accurately detect and classify cited with relationships. Such rules can be implemented in instructions and executed by processors (e.g., the instructions 116 and the processors 112 of FIG. 1). In some instances, the rules may be executed in a distributed manner, such as through a connection to network 160 such that cloud-based logic 162 may be employed.

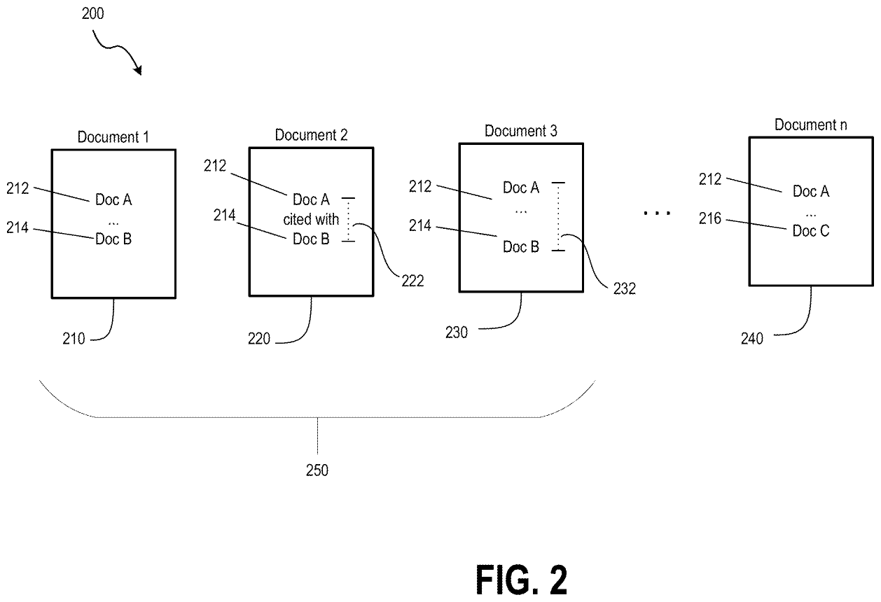

The feature generator 120 may be configured to cause the computing device 110 to perform operations for detecting, classifying, and generating records identifying a cited with relationship. In an aspect, the feature generator 120 may cause the one or more processors 112 to receive a plurality of documents. The plurality of documents may be received in some instances, for example, through the network 160 from one or more data sources 140. In other examples, the plurality of documents may be input directly to the computing device 110 through the I/O devices 126. An example of the functionality of feature generator 120 may be better understood with respect to FIG. 2, which shows a block diagram illustrating an exemplary plurality of documents in accordance with aspects of the present disclosure. FIG. 2 illustrates a plurality of documents 200, including a first document 210, a second document 220, a third document 230, and so on up to an Nth document 240. Each of the plurality of documents 200 may include legal citations, shown in FIG. 2 as legal citations 212, 214, and 216. The feature generator may be configured to detect the legal citations 212, 214, and 216 within each document of the plurality of documents. Legal citations typically have a standard form that can be recognized by a computer. For example, The Bluebook: A Uniform System of Citation is the most popular style manual describing the rules for how attorneys, judges and other legal professionals should cite to cases and authorities in legal documents. The Bluebook's style commonly tends to result in legal citations containing particular patterns of letters and numbers, especially when citing sources of law like court case decisions and statutes. In an aspect, the feature generator 120 may perform its detection of legal citations on a per document basis. Or in other words, the feature generator 120 may analyze one document at a time, such that at a given time it may detect all the legal citations in a given document of the plurality of documents 200. For example, the feature generator 120 may detect the presence of a first citation 212 to Doc A and the presence of a second citation 214 to Doc B in the first document 210. Other operations such as the following may be performed on a per-document basis.

The feature generator 120 may be configured to analyze each of the plurality of documents to detect a subset of documents in the plurality of documents. In some implementations, the subset of documents may be detected based on the legal citations within a given document. For example, the feature generator 120 may have determined that the first document 210 contains a first legal citation 212 to Doc A and a second legal citation 214 to Doc B. In this example, the feature generator 120 may be configured to identify each document in the plurality of documents 200 that contains a first legal citation 212 to Doc A and a second legal citation 214 to Doc B to identify a subset 250 of the plurality of documents 200. In this example, the subset 250 includes or corresponds to documents that contain citations to both Doc A and Doc B. In other words, the subset 250 was detected based on identification of documents containing both the legal citations 212 and 214. Thus, subset 250 includes or corresponds to documents 210, 220, and 230, but excludes document 240, which does not include a legal citation to Doc B. The first legal citation 212 to Doc A and the second legal citation 214 to Doc B are intended as examples of the kind of citations detected by the feature generator 120. It is expressly understood that any number of combinations of legal citations in a given document may be used to identify a subset of documents from the plurality of documents based on the legal citations in a given document. For example, a similar subset of documents could be formed based on the inclusion in Document N 240 of legal citations to Doc A and Doc C.

Although the documents in the subset 250 have been illustrated as sequentially adjacent to one another to provide a clear example, this should not be understood to limit the application of the present disclosure. For example, the plurality of documents 200 may be ordered in any order or no order at all. Thus, not all documents that contain a given legal citation need be present in the plurality of documents. Detecting the presence of legal citations in one document may be independent from detecting the presence of legal citations in another document. A pre-sorting of the documents based on their legal citations may not be required for these operations, although in some cases such pre-sorting may be beneficial (e.g., for facilitating efficient detection of legal citations). The legal citations in the several documents of the plurality of documents 200 also need not have any overlap with respect to one another. The overlap shown here is intended only as an example of the functionality for identifying the subset of documents based on the legal citations in a given document.

One exemplary way that a subset of documents could be identified based on the legal citations in a given document is through the use of document pairs. As a document is analyzed to identify legal citations or references, a document pair may be established between the document and the reference as each reference is identified. Document pairs may also be formed between the several references within the document. Using the example of FIG. 2 to illustrate, the feature generator 120 may analyze the first document 210 (e.g., Document 1) and determine that it includes a first citation 212 to Doc A and a second citation 214 to Doc B. The feature generator 120 may create a document pair representing a relationship between the documents corresponding to the citations. In an aspect, the relationship between the documents corresponding to the citations may be that they are both cited in the same document. In an aspect, the feature generator 120 may generate a document pair for each permutation of relationships. For example, a pair indicating Doc A and Doc B may be identified and associated with Document 1, 210, Document 2, 220, and Document 3, 230, and a pair indicating Doc A and Doc C may be identified and associated with Document n, 240. In some implementations, document pairs may be formed only for internal citations, such as, in this example, the pair of citations between Doc A and Doc B. In more complicated cases, more permutations will be available for forming pairs. For example, if a single case references 1000 other cases, there may be as many as 499,500 pairs of cases formed as a result of those citations.

Document pairs may be recorded as metadata. Additionally or alternatively, Document pairs may also be recorded in their own data structure. Other information may be captured at substantially the same time that a document pair is recorded, including as non-limiting examples, the location of a given citation within a given document, the proximity of two citations relative to one another, the number of times the given citation is included in the given document, and/or a point of law for which the given citation is cited.

The feature generator 120 may determine a proximity metric for each document of the subset of documents. The proximity metric may be associated with the legal citations within a given document. The proximity metric may be based on a set of proximity rules. For example, the proximity rules may be configured to determine how close two legal citations are to each other within a document. In some implementations, the proximity metric may be determined by determining the distance between the citations within the given document. Examples of techniques to determine a distance between citations may include counting characters between the citations, counting words between the citations, counting sentences between the citations, and/or counting paragraphs between the citations. As an additional non-limiting example, natural language processing or other data processing logic may be used to determine proximity metrics. For example, the documents analyzed in accordance with the concepts described herein may include extensible markup language (XML) markup or tags and proximity metrics may be determined based on the XML markup or tags. To illustrate, the XML markup or tags may include specific tags (e.g., <para>&</para> and <section>&</section>) that identify individual paragraphs and sections. To detect citations having a particular proximity metric content deemed insignificant (e.g., not related to or indicative of a citation) between two tags may be removed. If two citations exist between a set of corresponding tags (e.g., tags associated with a section, paragraph, etc.) above it is given the associated proximity. For example, if the document includes the following: <para>insignificant content “citation 1” insignificant content “citation_2” insignificant content</para>, removing the insignificant content (e.g., content not indicative of a legal citation) would result in “citation 1” and “citation_2” remaining, which may be detected as a string cite having paragraph proximity. However, if the document included<section><para>“insignificant content 1” “insignificant content 2” “insignificant content</para></section>, removing the insignificant content would result in no detection of citations (i.e., because all content within the section and paragraph were deemed insignificant). It is noted that there may be multiple proximity metric levels, such as when two citations are present in the same document (e.g., document proximity), when the two legal citations are present in the same section and/or subsection of the document (e.g., section proximity), when the two legal citations are present in the same paragraph or within one or two paragraphs of each other (e.g., paragraph proximity), and/or when the two legal citations are present in the same sentence (e.g., sentence proximity). In some implementations, two citations in a document may be associated with more than one proximity metric. In some implementations, when multiple proximity levels or metrics are associated with a given set of citations, a narrower proximity metric may be used (e.g., paragraph proximity instead of section proximity, sentence proximity instead of paragraph proximity, etc.).

For example, FIG. 2 shows that in the second document 220 (Document 2) there is a proximity metric 222 corresponding to the legal citations 212 and 214. In the case of Document 2, the citation 212 to Doc A is cited with the citation 214 to Doc B. According to this example, the proximity metric 222 may be at least an initial indicator that Doc A is cited with Doc B in Document 2. Similarly, the third document 230 (Document 3) includes a proximity metric 232 corresponding to the legal citations 212 and 214. In the case of Document 3, the citation 212 to Doc A is not cited with the citation 214 to Doc B. According to this example, the proximity metric 232 may be at least an initial indicator that Doc A is not cited with Doc B in Document 3. In some examples, if a legal citation is repeated in more than one place in a document, the proximity metric may identify the closest proximity between two legal citations. In other examples, the proximity metric may include both proximities. In some instances where more than one proximity may be included in the proximity metric, a weighting may be applied to the two proximities so that the two proximities may be distinguished or otherwise located. While the proximity metric has been described with respect to only two legal citations within a document, it should be understood that the proximity metric may include or correspond to more than two legal citations within a document.

The feature generator 120 may be configured to prune the subset of documents based on the proximity metrics and a set of contextual rules to produce a reduced set of documents. In some implementations, the reduced set of documents may include or correspond to a portion of the subset of documents in which the legal citations have a cited with relationship. In the example of FIG. 2, the reduced set of documents would include or correspond to the second document 220, Document 2, as Document 2 includes Doc A cited with Doc B. As discussed above, the proximity metric may be an initial indicator of whether one legal citation is cited with another legal citation within the same document. For example, in some instances, legal citations having only document proximity to one another may not be cited with one another. Suppose, for example, that a case law document contains a first legal citation for a point of law related to a procedural section, and a later section in the document contains a second legal citation for a point of law related to a substantive legal issue. In this example, the first legal citation may not be cited with the second legal citation because they are not necessarily cited for the same point of law, as may be indicated by their relatively distant proximity to each other (e.g., only document proximity and nothing closer). However, as noted above, legal citations identified as being “cited with” each other in accordance with the concepts described herein may not necessarily involve a same point of law.

In some aspects, a set of contextual rules may be applied during processing of “cited with” citations. for example, the set of contextual rules may be configured to identify markers corresponding to the legal citations within each document of the subset of documents. The markers may include or correspond to legal citation signals. Non-limiting examples of legal citation signals include no signal (e.g., a direct citation), a see signal, a see also signal, an accord signal, an e.g. signal, a c.f. signal, a compare . . . with signal, a but see signal, a but c.f. signal, and/or a contra signal. Such markers may be distinguished and/or classified by the set of contextual rules as supportive, comparative, and/or contradictory based on the markers. For example, supportive markers may include no signal, a see signal, a see also signal, an accord signal, an e.g. signal, and/or a c.f. signal. Comparative signals may include a c.f. signal, and/or a compare . . . with signal. Contradictory signals may include a but see signal, a but c.f. signal, and/or a contra signal. It is noted that the exemplary signals described above have been provided for purposes of illustration, rather than by way of limitation and that other types of signals may also be utilized in accordance with the concepts described herein. In an aspect, the set of signals may be used to control of how cited with content is displayed (e.g., to show only cases cited with a given case in a supportive fashion or contradictory fashion).

In some implementations, the markers may include punctuation marks. Some punctuation marks are typical of legal citations and of cited with relationships in particular. For example, in the particular case of a string cite (e.g., a listing of multiple legal citations within the same sentence), legal citations are typically separated by semicolons. In some examples, parenthesis and quotation marks are also employed. String cites are of particular interest, because legal citations in a string cite are frequently if not always cited with each other. For example, the following quoted material from Mueller v. Rodin, 2021 WL 2592394 (S. D. Fla. 2021) includes a string cite showing that the case of Chemung Canal Tr. Co. v. Sovran Bank/Maryland is cited with the Travelers Cas. & Sur. Co. of Am. v. IADA Services, Inc. case, among others:
The Eleventh Circuit has not explicitly decided whether contribution or indemnity claims between co-fiduciaries are viable under the ERISA as an extension of trust law principles. See Guididas v. Cmty. Nat. Bank Corp., No. 11-cv-2545, 2012 U.S. Dist. LEXIS 158404, 2012 WL 5974984, at *3 (M. D. Fla. Nov. 5, 2012). Other circuits are divided on the issue. Compare Chemung Canal Tr. Co. v. Sovran Bank/Maryland, 939 F.2d 12, 18 (2d Cir. 1991) (permitting contribution or indemnity), and Chesemore v. Fenkell, 829 F.3d 803, 813 (7th Cir. 2016) (same); with Travelers Cas. & Sur. Co. of Am. v. IADA Services, Inc., 497 F.3d 862, 867 (8th Cir. 2007) (not permitting), and Kim v. Fujikawa, 871 F.2d 1427, 1433 (9th Cir. 1989) (same).
   Bolded text added for clarity and emphasis. In this case, the Chemung case is cited with the Travelers case in a comparative way. The Chesemore v. Fenkell and Kim v. Fujikawa cases are similarly cited with each other, with Chemung, and with Travelers, in each of the various permutations of combinations possible.

Cited with relationships need not be based only on legal citations located in the same sentence. Indeed, other structures within a document may contribute to identifying a cited with relationship. In the above example, the each of the Chemung, Chesemore, Travelers, and Kim cases may also be considered to be cited with the Guididas case cited at the beginning of the same paragraph based on the context of the document. The contextual rules may be configured to determine a context for citations in order to determine if they are cited with each other. In some implementations, the contextual rules may be configured to determine a structure for each document of the subset of documents. The structure may identify an organization of structural elements within each document. Structural elements may include sections, subsections, paragraphs, lists, and/or sentences. The location of legal citations within a document structure may correspond to whether they are cited with each other. Other contexts may determine a cited with relationship. For example, contextual rules may be configured to analyze the text surrounding legal citations and to determine whether the legal citations are part of the same context. For example, a citations that are grouped with multiple legal citations within the same sentence, but preceded by language such as “quoting” or “citing” may not be considered string cites for the purpose of identifying cited with relationships. It is noted that cases in a direct line may be excluded from being identified as “cited with” content. As another example, the context of each legal citation may be analyzed using text analysis techniques, such as, for example, text classification, text extraction, fuzzy string matching, keyword analysis, collocation, concordance, word sense disambiguation, natural language processing (NLP), clustering, and/or other machine learning or textual analysis techniques as would be understood by one of skill in the art.

In some implementations, the set of contextual rules may be configured to associate the legal citations and the proximity metric with one or more of the structural elements. In some examples, this associating may be performed for each document of the plurality of documents. Alternatively, in some exemplary implementations, the associating may be performed for each document of the subset of documents (e.g., subset 250 of FIG. 2). In cases where associating is only performed for the subset of documents, processor power may be conserved by only applying contextual rules to documents known to contain citations containing the given citations.

In some implementations, pruning the subset of documents may include applying contextual rules to each document within the subset of documents having a set of legal citations associated with proximity metrics satisfying a threshold proximity metric. For example, suppose that it is known for certain classes of documents that legal citations that do not have at least section proximity with respect to one another cannot be cited with each other. In such a case there would be no need to apply contextual rules to those document classes when a proximity metric could just as accurately determine there is no cited with relationship for the legal citations.

Returning to FIG. 1, the feature generator 120 may be configured to generate one or more records in a metadata database (e.g., one of the databases 118). In some implementations, each of the one or more records may include metadata. For example, the metadata may be associated with a document in which legal citations having a cited with relationship were identified. Alternatively or additionally, the metadata may be associated with each document associated with each of the legal citations having the cited with relationship. In examples such as those discussed above where the subset of documents is pruned to produce a reduced set of documents (e.g., documents which all contain a specific subset of legal citations that have a cited with relationship with each other), the metadata may identify at least one document within the reduced set of documents and the legal citations having the cited with relationship within the at least one document. Storing records including metadata identifying documents and citations associated with cited with relationships may enable the later searching and identification of such documents.

In some implementations, the generating of records in a metadata database may be performed on a daily basis. This may be done, for example, to provide researchers, legal professionals, and/or others the most up-to-date information regarding cases, including cited with relationships. In some instances, other databases may be updated daily in addition to the metadata database. For instance, a document database may be updated to include the plurality of documents, or to update connections to documents identified by but not necessarily included in some documents of the plurality of documents.

The computing device 110 may also include a search engine 122. Search engine 122 may be configured to search the one or more databases 118. For example, search engine 122 may be configured to receive search queries and return search results. Search queries may be received from inputs to the I/O Devices 126, such as, for example, by a user entering a search query with a keyboard or by using a mouse to click on interactive elements in a graphical user interface (GUI). Search queries may also be received by the computing device 110 through the network 160 by the communication interfaces. For example, a search query may be first generated at a second computing device 130, either through instructions 136 stored in memory 134 or through inputs to the second computing device through input/output devices 139. If a search query is generated at computing device 130, then it may be communicated via the communication interfaces 138, through the network 160, and to the computing device 110.

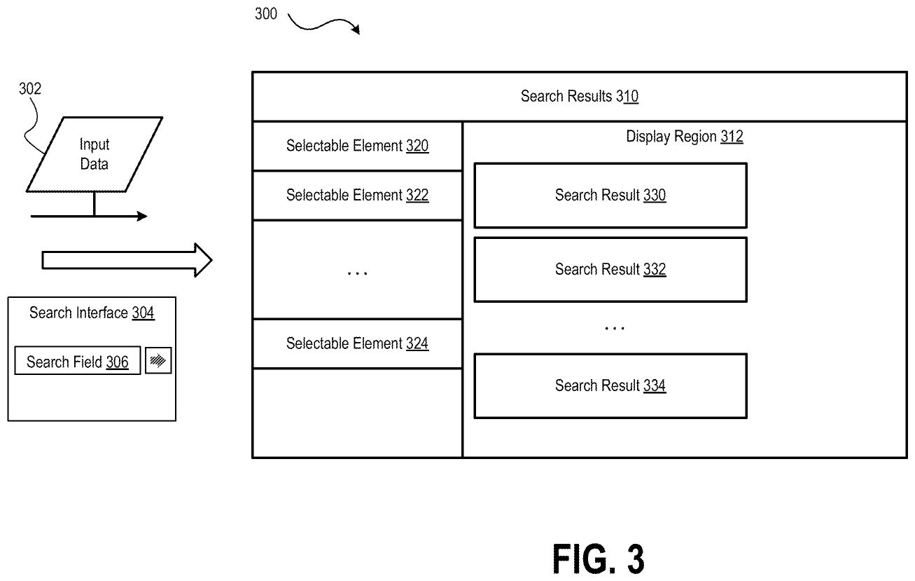

An example of the functionality of the search engine 122 described herein may be better understood with regard to FIG. 3, which is a block diagram illustrating an exemplary GUI 300 for displaying information associated with search results obtained in accordance with aspects of the present disclosure. The search engine 122 may be configured to receive search parameters via inputs to the GUI 300. For example, the search engine 122 may receive input data 302 (e.g., search parameters). In some exemplary implementations, input data 302 may be input through a search interface 304 via a search field 306. Search interface 304 may be an example of an aspect of GUI 300. Input data 302 may include a search query. Non-limiting examples of a search query may include a natural language search query, a Boolean search query, a selection of inputs from a set of potential search queries (e.g., from a dropdown menu or other graphical element), a legal citation, a case name, a partial legal citation, or any combination thereof. Input data 302 may include search parameters. In some implementations, search parameters may restrict the search to identify documents meeting the parameters. For example, the input data 302 may include search parameters to search for documents related to a specific geographical region, search parameters to search for documents related to a specific legal jurisdiction, search parameters to search for documents produced within a specified date range, a search parameters to search for documents (e.g., court case decisions) from a specific court, search parameters to search for specific legal issues, search parameters to search for specific types of documents, or any combination thereof. A search query and/or a selection of search parameters may be used separately and/or in combination.

The search engine 122 may be configured to execute a search of a document database based on the search parameters to identify a set of search results. For example, the search engine 122 may perform a search of one or more of the databases 118 (e.g., document database(s)) and/or the one or more data sources 140. In some implementations, each search result of the set of search results may include or correspond to a particular document of a plurality of documents associated with the document database and/or the one or more data sources 140.

The search engine 122 may be configured to output the set of search results to the GUI 300. The GUI 300 may include one or more selectable elements for viewing the documents corresponding to set of search results. By way of illustration and not limitation, FIG. 3 shows a GUI 300 including a set of search results 310, a display region 312, a plurality of selectable elements 320, 322, and 324. The display region 312 may be configured to display and/or output the set of search results 310, which may include search result 330, search result 332, and so on up to search result 334. The search results 330, 332, and 334 may include or correspond to selectable elements. Each search result of the set of search results 310 may be displayed at a given time. Alternatively, only a portion of the search results 310 may be displayed at a given time to facilitate ease of reading. The search results may be displayed according to a rank. A rank of the search results may be determined based on the relevance of the search results to the input data 302 (e.g., a given search query and/or set of search parameters). Alternatively, or additionally the rank of the search results may be determined based on other settings or configurations. For example, a user may have selected certain parameters related to how search results are ranked, and so the search results may be configured according to a user preference.

The one or more selectable elements of GUI 300 may include selectable elements configured to prune and/or sort the search results. For example, selecting one of the one or more selectable elements 320, 322, or 324 may cause search engine 122 to output a subset of the set of search result corresponding to the selectable element. Other non-limiting examples of functionality for the selectable elements include displaying a document including or corresponding to one of the search results, changing how the search results are displayed (e.g., changing a display format), displaying and/or hiding a summary of a search result, suggesting additional searches, previewing elements related to the search results, and/or highlighting or removing highlighting from keywords corresponding to the search results.

The search engine 122 may be configured to receive an input corresponding to selection of a first selected element of the one or more selectable elements, the first selected element corresponding to a particular search result of the set of search results. For example, the input could include or correspond to any one of the search results 330, 332, or 334. The search engine 122 may be further configured to display based on the input, a document corresponding to the particular search result. For example, in some implementations, search engine 122 may cause a display device of the I/O devices 126 (e.g., a monitor, the display screen of a tablet, phone, or other mobile device) to display the document in, for example, a new instance of the GUI 300, a new page within the GUI 300, a new window, a new browser tab, or some other similar instance in which the document appears on its own screen for viewing. In other implementations, the document may be displayed within or among the search results display of GUI 300. One example of this could be to expand the selected search result to display at least a portion of the document. Another example may include displaying the document in a separate portion of the display region 312, such as to the right of the search results displayed. In such implementations, to accommodate displaying the document, the search results 330, 332, or 334 not corresponding to the document may be collapsed, minimized or diminished in size, or moved to a different portion of the display region 312. In still another example, displaying the document within or among the search results display of GUI 300 could include displaying the document over the top of the display region 312 by a fly-out window, a drop-down window or a pop-up display. The particular implementation may be selected or determined in advance based on configurations determined according to a user preference.

The search engine 122 may be configured to initiate a second search based on a second input received during display of the document corresponding to the particular search result. For example, the second search may be performed as a result of a user selecting a selectable element corresponding to showing other documents cited with the document corresponding to the particular search result. The second search may include querying a metadata database to identify additional search results. The additional search results may include or correspond to other documents of the plurality of documents (e.g., documents stored in a document database). The other documents may each include citations having a cited with relationship with respect to the document corresponding to the particular search result and an additional document of the plurality of documents. For example, suppose that a user had selected a search result corresponding to Doc A, and then had selected a “cited with” selectable element within or corresponding to the display of Doc A. In this example, the search engine 122 would query a metadata database to return search results that include documents citing Doc A with other documents (e.g., Doc B, Doc C, and so on) to the extent that there are documents citing Doc A with another document. Alternatively, the other documents may include or correspond to documents cited with the first document. For example, suppose that a user had selected a search result corresponding to Doc A, and then had selected a “cited with” selectable element within or corresponding to the display of Doc A. In this example, the search engine 122 would query a metadata database to return search results that include documents cited with Doc A in at least one other document. Further examples are illustrated below.

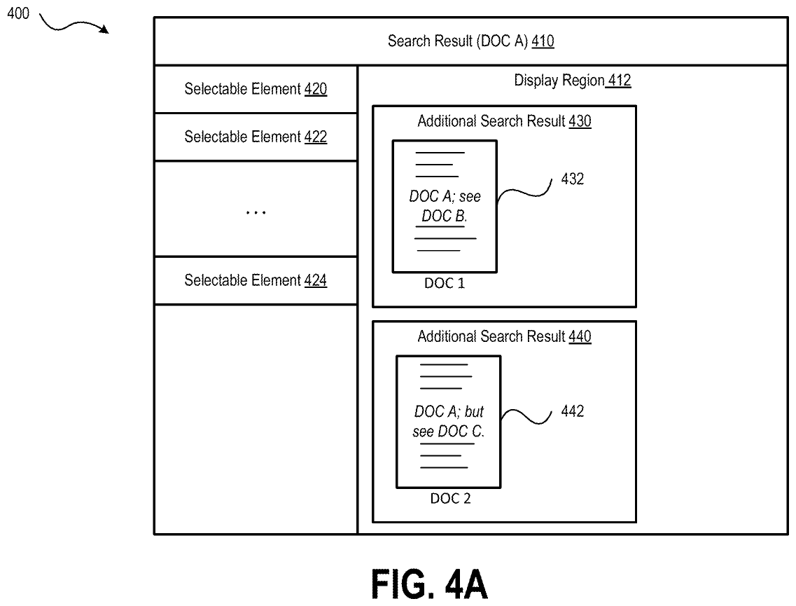

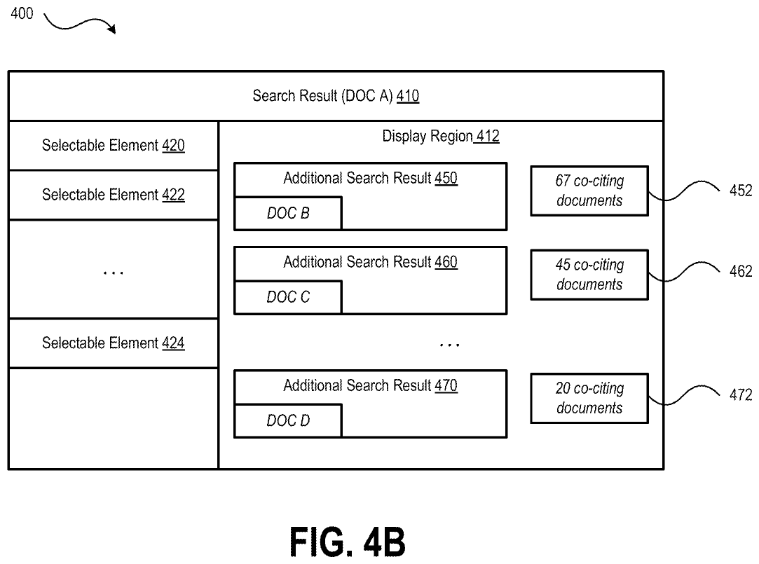

The search engine 122 may be configured to output the additional search results to the GUI. This may be better understood with reference to FIGS. 4A and 4B, which each illustrate an exemplary graphical user interface for displaying information associated with search results obtained in accordance with aspects of the present disclosure as GUI 400. GUI 400 includes a display of a search result 410, which in this example corresponds to Doc A. GUI 400 also includes a plurality of selectable elements 420, 422, and so on through 424, a display region 412, and additional search results 430 and 440. FIG. 4A is intended as an illustration and not a limitation on the kind of functionality described. For example, more additional search results than just 430 and 440 may be displayed, provided that there are additional search results available corresponding to documents citing Doc A with another document. As another example, FIG. 4B illustrates a display region 412 displaying additional search results 450, 460, and 470 corresponding to documents cited with Doc A (e.g., Doc B, Doc C, or Doc D), and including selectable elements 452, 462, and 472 for viewing additional documents citing to both Doc A and another document. FIG. 4B is intended as an illustration and not a limitation on the kind of functionality described. In the example of FIG. 4B, the additional search results may be sorted based on the number of documents in which Doc A is cited with the additional search result document. For example, Doc B is displayed at the top of the display region 412 because it is co-cited with Doc A in more other documents than the others of Doc C and Doc D. FIGS. 4A and 4B may be understood to present alternative configurations of a GUI 400. FIG. 4B may also be understood to be a successive interfaces to that of FIG. 4A, or vice versa. For example, in response to an input, the GUI 400 may present one or the other interfaces, or it may present some combination of the two. It is noted that the interfaces described above have been provided for purposes of illustration, rather than by way of limitation and that other types of interfaces may also be utilized in accordance with the concepts described herein.

In some implementations, the search engine 122 may be configured to generate, for a given additional search result of the additional search results, a summary of a portion of the document corresponding to the additional search result. The search engine 122 may also be configured to output the summary to the GUI 400. Referring to the example illustration of FIG. 4A, the display region 412 may output with additional search result 430 a summary 432. Similarly, FIG. 4A illustrates a summary 442 corresponding to additional search result 440. The summary may include a portion of the document including or corresponding to a first legal citation corresponding to the particular search result and a second legal citation corresponding to the additional document. For example, summary 432 includes a portion of Doc 1 which contains a legal citation to Doc A and a legal citation to Doc B. As a further example, summary 442 includes a portion of Doc 2 which contains a legal citation to Doc A and a legal citation to Doc C. The summary may demonstrate how the first and second legal citations have a cited with relationship with respect to one another. For example, in summary 432, Doc A is cited in a string cite with Doc B. and it can be seen that Doc B supports the point of law for which Doc A is cited because of the see signal used in this instance. In the example of summary 442, Doc A is cited in a string cite with Doc C. and it can be seen that Doc C illustrates a contrary or contrasting point of law for which Doc A is cited because of the but see signal used. It is noted that the exemplary summaries described above have been provided for purposes of illustration, rather than by way of limitation and that other types of summaries may also be utilized in accordance with the concepts described herein. Similar summaries may be generated for the additional search results 450, 460, and 470 illustrated in the example of FIG. 4B.

In some exemplary implementations, the summary 432 and/or the summary 442 may include highlighting of the legal citations having a cited with relationship. The highlighting may be done in contrasting colors for each legal citation. In the event that a selection is made to view a document including a cited with relationship, the contrasting highlighting may be continued into the display of that document so that the cited with relationship may be more easily located and/or analyzed.

The search engine 122 may be configured to sort the additional search results upon display. For example, the additional search results may be sorted by the frequency of how many times a document corresponding to the additional cited with respect to the search result as in FIG. 4B. For example, the additional search results could also be sorted by date, most cited, most used, court level and/or some other criteria. Additionally, the one or more selectable elements 420, 422, and 424 of FIGS. 4A and 4B could include a selectable element for sorting or re-sorting the additional search results.

The selectable elements 420, 422, and 424 of GUI 400 may be configured to perform a number of operations in addition or in the alternative to those already discussed. For example, the selectable elements may be configured to filter the additional search results based on any number of criteria. Non-limiting examples of selectable elements may include filters for the kind of citing with relationship present between documents. For example, there may be filters to show documents with no direct citing relationship, documents cited by the first document, and documents that cite to the first document. Filters such as these may be beneficial to separate documents that may be more easily discovered because of their direct citing relationship. In the case of identifying a circuit split, for example, there may be no direct citing relationship between the seminal cases in each circuit, and yet other cases may identify the split by citing the cases together. Another non-limiting example of filters may include filters for the level of a cited with relationship. For example, whether two documents are cited with each other to support, to compare, to contrast, or to contradict a point of law. Still other examples of filters may include filters based on citing proximity (e.g., section proximity, paragraph proximity, sentence proximity, and/or string cite proximity), jurisdictional filters, court level filters, and/or date filters.

Another example of a selectable element in this context includes selectable elements 452, 462, and 472 of FIG. 4B. Selectable element 452 may be configured to cause a list of documents citing both search result 410 and the additional search result 450 to be displayed. For example, receiving an input corresponding to one of selectable elements 452 may cause a list of all documents citing Doc A (e.g., a document associated with search result 410) with Doc B (e.g., a document associated with search result 450) to be displayed. Selectable element 462 may cause a list of documents citing Doc A (e.g., a document associated with search result 410) with Doc C (e.g., a document associated with search result 460) to be displayed. Selectable element 472 may cause a list of documents citing Doc A (e.g., a document associated with search result 410) with Doc D (e.g., a document associated with search result 470) to be displayed. The display may include contrasting highlighting of the legal citations having a cited with relationship and/or other relevant text (e.g., as may be related to a point of law, terms from filters, and/or search query terms). In some implementations, the list of co-citing documents may maintain at least some of the filters applied at a previous stage, such as, for example, the level of citing with relationship or whether there exists a direct citing relationship. Additionally, or alternatively, some of the filters may not be carried through to the list of co-citing documents. For example, filters and/or search parameters restricting the jurisdictional scope of documents may not be applied during display of co-citing documents so that circuit splits may be more readily identified. It is noted that the exemplary filters and other selectable elements described above have been provided for purposes of illustration, rather than by way of limitation and that other types of selectable elements may also be utilized in accordance with the concepts described herein.

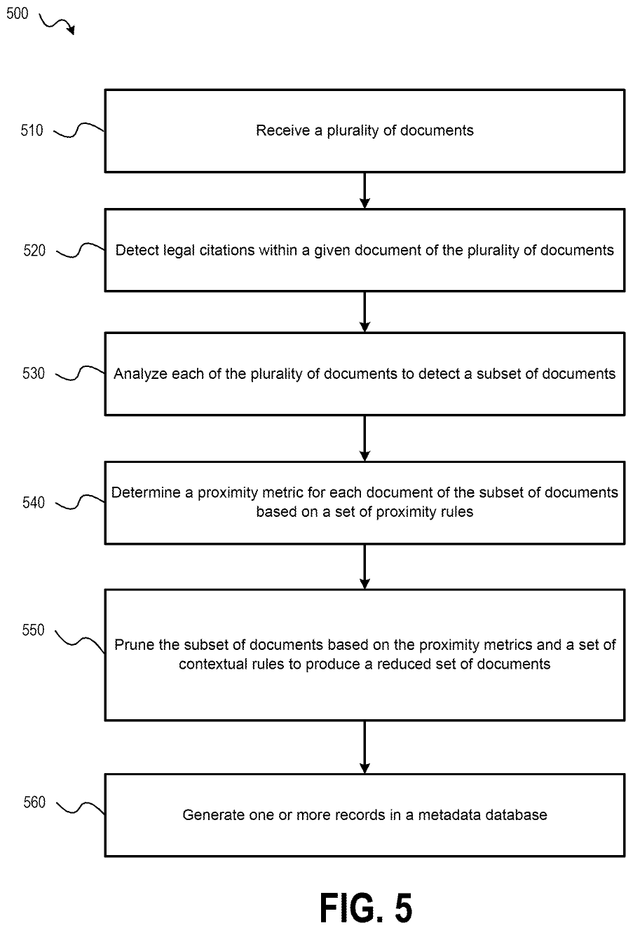

Referring to FIG. 5, a flow diagram of an exemplary method for detecting a cited with relationship in accordance with aspects of the present disclosure is shown as a method 500. In an aspect, steps of the method 500 may be performed by a computing device, such as the computing device 110 of FIG. 1. Additionally, the steps of the method 500 may be stored as instructions (e.g., the instructions 116 of FIG. 1) that, when executed by one or more processors (e.g., the one or more processors 112 of FIG. 1), cause the one or more processors to perform the method 600 in accordance with the concepts described herein. It is noted that the method 500 may be performed via other implementations as well, such as via implementation on cloud-based logic 162 of FIG. 1.

At step 510, the method 500 includes receiving, by one or more processors, a plurality of documents. As explained above with reference to FIGS. 1 and 2, the plurality of documents may include legal citations. In an aspect, the plurality of case law documents may include case law documents. At step 520, the method 500 includes detecting, by the one or more processors, legal citations within a given document of the plurality of documents. In an aspect, the detecting may be performed as described above with reference to FIGS. 1 and 2.

At step 530, the method 500 includes analyzing, by the one or more processors, each of the plurality of documents to detect a subset of documents in the plurality of documents. As explained above with reference to the feature generator 120 of FIG. 1, in some implementations, the subset of documents may be detected based on the legal citations within the given document.

At step 540, the method 500 includes determining, by the one or more processors, a proximity metric for each document of the subset of documents based on a set of proximity rules. In an aspect, the proximity metric may be associated with the legal citations within the given document, as described above with reference to FIGS. 1 and 2. In some aspects, the set of proximity rules may classify the legal citations within a particular document relative to one another as having at least one of a document proximity, a section proximity, a paragraph proximity, or a sentence proximity.

In an aspect, as described above, the set of contextual rules in step 540 may be configured to identify markers corresponding to the legal citations within each document of the subset of documents, and/or determine a structure for each document of the subset of documents. In an aspect, as described above with reference to FIGS. 1 and 2, the markers may include legal citation signals. In an aspect, the set of contextual rules may be configured to classify the cited with relationship as supportive, comparative, or contradictory based on the markers. In an aspect, the structure may identify an organization of structural elements within each document of the subset of documents. Such structural elements may include or correspond to sections, paragraphs, sentences, or a combination thereof. In an aspect, as described above, the set of contextual rules may be configured to associate the legal citations and the proximity metric with one or more structural elements of the structure for each document of the subset of documents. In an aspect, the contextual rules may be configured in any combination of the above configurations.

At step 550, the method 500 includes pruning, by the one or more processors, the subset of documents based on the proximity metrics and a set of contextual rules to produce a reduced set of documents. As described above with reference to the feature generator 120 of FIG. 1, the reduced set of documents may include or correspond to a portion of the subset of documents in which the legal citations have a cited with relationship. As described above, the cited with relationship may indicate that a particular document cites to a first legal citation and a second legal citation, where the first legal citation and the second legal citation may be cited for a same or different point of law. In an aspect, the pruning may include applying contextual rules to each document within the subset of documents having a set of legal citations associated with proximity metrics satisfying a threshold proximity metric.

At step 560, the method 500 includes generating, by the one or more processors, one or more records in a metadata database. In an aspect, each of the one or more records may include or correspond to metadata that identifies at least one document within the reduced set of documents and the legal citations having the cited with relationship within the at least one document. As discussed above with reference to FIGS. 1 and 2, the generating may be performed daily.

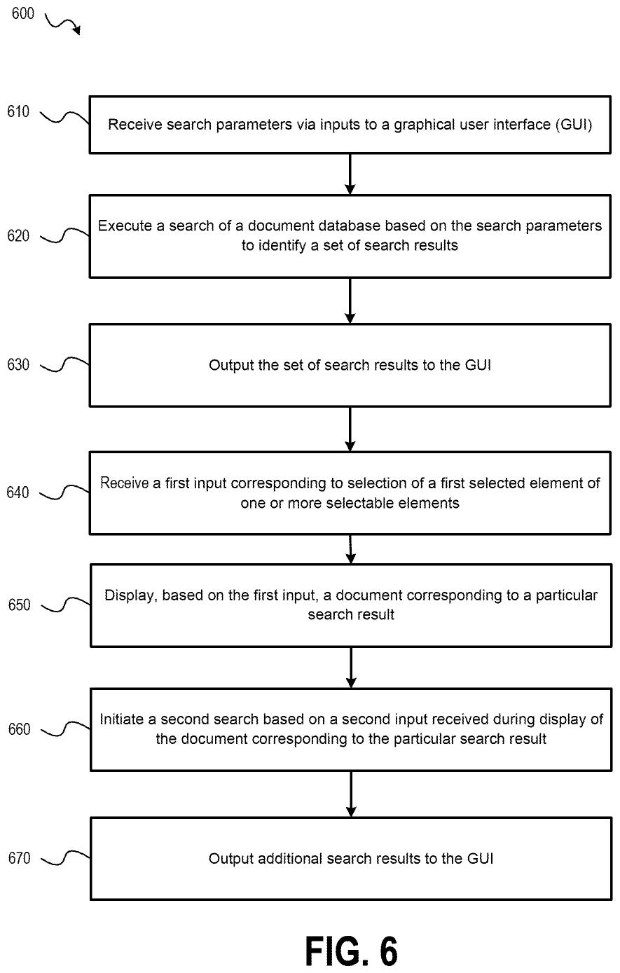

Referring to FIG. 6, a flow diagram of an exemplary method for searching for cited with relationships in accordance with aspects of the present disclosure is shown as a method 600. In an aspect, steps of the method 600 may be performed by a computing device, such as the computing device 110 of FIG. 1. Additionally, the steps of the method 600 may be stored as instructions (e.g., the instructions 116 of FIG. 1) that, when executed by one or more processors (e.g., the one or more processors 112 of FIG. 1), cause the one or more processors to perform the method 600 in accordance with the concepts described herein. It is noted that the method 600 may be performed via other implementations as well, such as via implementation on cloud-based logic 162 of FIG. 1.

At step 610, the method 600 includes receiving, by one or more processors, search parameters via inputs to a graphical user interface (GUI). As discussed above with reference to the processors 112 and the search engine 122 of FIG. 1 and the GUI 300 of FIG. 3, the search parameters may include various forms of input data. At step 620, the method 600 includes executing, by the one or more processors, a search of a document database based on the search parameters to identify a set of search results. In an aspect, and as described above, each search result of the set of search results may include or correspond to a particular document of a plurality of documents associated with the document database.

At step 630, the method 600 includes outputting, by the one or more processors, the set of search results to the GUI. In an aspect, as described with reference to FIGS. 1 and 3, the GUI may include one or more selectable elements. In an aspect, the one or more selectable elements may correspond to operations for viewing the documents corresponding to the set of search results.

At step 640, the method 600 includes receiving, by the one or more processors, a first input corresponding to selection of a first selected element of the one or more selectable elements. In an aspect, and as described above relative to the search engine 122 of FIG. 1, the first selected element may include or correspond to a particular search result of the set of search results. At step 650, the method 600 may include displaying, based on the first input, a document corresponding to the particular search result. As discussed above with respect to FIGS. 4A and 4B, the document may be displayed in a GUI, such as, for example, GUI 400.

At step 660, the method 600 includes initiating, by the one or more processors, a second search based on a second input received during display of the document corresponding to the particular search result. In an aspect, the second search includes querying a metadata database to identify additional search results. As described above, the additional search results may include or correspond to other documents of the plurality of documents that identify a cited with relationship with respect to the document corresponding to the particular search result and an additional document of the plurality of documents.

At step 670, the method 600 may include outputting, by the one or more processors, the additional search results to the GUI. As discussed above with reference to FIGS. 1 and 4A, in an aspect, the additional search results may be output by reference to documents that identify or include a cited with relationship between legal citations in the documents. Additionally or alternatively, as discussed above with reference to FIGS. 1 and 4B, in an aspect, the additional search results may be output by reference to other documents cited with the document. For example, in an aspect, the additional search results may be displayed based on how frequently other documents are cited with the document displayed during step 650.

The method 600 may include operations including generating, for a given additional search result of the additional search results, a summary of a portion of the document corresponding to the given additional search result and outputting the summary to the GUI. In an aspect, the portion of the document may include or correspond to a first legal citation corresponding to the particular search result and a second legal citation corresponding to the additional document. In an aspect, the first and second legal citations may have a cited with relationship with respect to one another.

The cited with relationship referred to above and with respect to step 660 may be detected and/or determined following a method similar to the method described above with respect to FIG. 5. For example, in an aspect, the cited with relationship may be determined by detecting, by the one or more processors, legal citations within a given document of the plurality of documents, determining, by the one or more processors, a proximity metric for the given document based on a set of proximity rules, and evaluating, by the one or more processors, the given document based on the proximity metric and a set of contextual rules. In an aspect, the proximity metric may be associated with the legal citations within the given document. In an aspect, the markers may include or correspond to legal citation signals. In an aspect, the set of contextual rules is configured to classify the cited with relationship as supportive, comparative, or contradictory based on the markers.

As discussed relative to the databases 118 of FIG. 1 discussed above, databases may be updated on a daily basis. In an aspect, the metadata database may be updated daily. For example, as new documents are received (e.g., on a daily basis), new cited with relationships may be identified. Metadata related to documents and legal citations corresponding to the cited with relationships may be generated (e.g., in metadata records) as the cited with relationships are identified, and such metadata may be stored in records on the metadata database. Similarly, the document database may also be updated daily. In an aspect, updating the document database may include updating documents to reflect newly identified cited with relationships.

In an aspect, the method 500 of FIG. 5 may be combined with the method 600 of FIG. 6. For example, upon completion, the method 500 may continue from step 560 into the method 600 of FIG. 6, starting with step 610. Additional aspects as have been described above relative to the methods individually may likewise be incorporated into aspects in which the methods are combined into a single method.

The systems and methods described herein thus provide several benefits. For example, a system (e.g., system 100 of FIG. 1) including a feature generator (e.g., feature generator 120 of FIG. 1) configured to detect and generate features identifying cited with relationships may enable the use of cited with relationships by users as they conduct their research tasks. Systems having search engines (e.g., search engine 122 of FIG. 1) configured to search for cited with relationships may enable researchers to more quickly identify relationships between legal documents. Having cited with relationships available to researchers, such as in a display or a graphical user interface (e.g., the GUI 300 of FIG. 3, or the GUI 400 of FIGS. 4A and 4B) may also enable researchers to more quickly and/or more thoroughly understand certain legal issues, such as, for example, circuit splits, comparative points of law, and/or nuances within point of law. Methods of detecting, classifying, and searching for citations having a cited with relationship such as described herein thus promote efficient and effective researching.

As discussed above, the vast number of legal documents in existence and produced daily cannot reasonably be parsed by a human researcher without consuming large amounts of time. Even for a skilled researcher or team of researchers, such a project could take time on the order of months to years. Updating data systems daily to account for new connections for the millions of documents can still take significant computer time, but is significantly faster than human efforts—e.g., on the order of hours. For example, the millions of documents with potentially billions of features corresponding to metadata, proximity metrics, cited with relationships, document pairs, and more can be processed on computing devices (such as computing device 110 of FIG. 1) cloud-based logic (e.g., cloud-based logic 162 of FIG. 1) or over a distributed computing environment may be processed in hours. In a particular example, detecting cited with relationships in document, generating features associated with the cited with relationships, and updating every document in a database or data system can take 5 hours per night leveraging 300 virtual cores processors in a distributed computing environment. In this particular example, this results in approximately 3200 normalized computing hours per day. In order to provide the most up-to-date information to researchers, the update should be performed daily.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-6 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means “and” or “or.”

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus or system that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method comprising:
receiving, by one or more processors, a plurality of documents, each document of the plurality of documents comprising legal citations;
detecting, by the one or more processors, legal citations within a given document of the plurality of documents;
analyzing, by the one or more processors, each of the plurality of documents to detect a subset of documents in the plurality of documents, the subset of documents detected based on the legal citations within the given document;
determining, by the one or more processors, a proximity metric for each document of the subset of documents based on a set of proximity rules, the proximity metric associated with the legal citations within the given document;
pruning, by the one or more processors, the subset of documents based on the proximity metrics and a set of contextual rules to produce a reduced set of documents, the reduced set of documents corresponding to a portion of the subset of documents in which the legal citations have a cited with relationship; and
generating, by the one or more processors, one or more records in a metadata database, wherein each of the one or more records comprises metadata that identifies at least one document within the reduced set of documents and the legal citations having the cited with relationship within the at least one document.

2. The method of claim 1, wherein the plurality of documents comprises case law documents, and wherein the cited with relationship indicates that a particular document cites to a first legal citation and a second legal citation.

3. The method of claim 1, wherein the set of proximity rules classifies the legal citations within a particular document relative to one another as having at least one of a document proximity, a section proximity, a paragraph proximity, or a sentence proximity.

4. The method of claim 1, wherein the set of contextual rules is configured to:
identify markers corresponding to the legal citations within each document of the subset of documents;
determine a structure for each document of the subset of documents, wherein the structure identifies an organization of structural elements within each document of the subset of documents, wherein the structural elements include sections, paragraphs, sentences, or a combination thereof; or
a combination thereof.

5. The method of claim 4, wherein the markers comprise legal citation signals, and wherein the set of contextual rules is configured to classify the cited with relationship as supportive, comparative, or contradictory based on the markers.

6. The method of claim 4, wherein the set of contextual rules is configured to associate the legal citations and the proximity metric with one or more structural elements of the structure for each document of the subset of documents.

7. The method of claim 1, wherein the pruning further comprises applying contextual rules to each document within the subset of documents having a set of legal citations associated with proximity metrics satisfying a threshold proximity metric.

8. The method of claim 1, wherein the generating is performed daily.

9. The method of claim 1, further comprising:
receiving, by the one or more processors, search parameters via inputs to a graphical user interface (GUI);
executing, by the one or more processors, a first search of a document database based on the search parameters to identify a set of search results, each search result of the set of search results corresponding to a particular document of a second plurality of documents associated with the document database;
outputting, by the one or more processors, the set of search results to the GUI, wherein the GUI comprises one or more selectable elements for viewing the documents corresponding to the set of search results;
receiving, by the one or more processors, a first input corresponding to selection of a selected element of the one or more selectable elements, the selected element corresponding to a particular search result of the set of search results;
displaying, based on the first input, a document corresponding to the particular search result;
initiating, by the one or more processors, a second search based on a second input received during display of the document corresponding to the particular search result, wherein the second search comprises:
querying the metadata database to identify additional search results, the additional search results corresponding to other documents of the second plurality of documents associated with the document database that identify a cited with relationship with respect to the document corresponding to the particular search result and an additional document of the second plurality of documents; and
outputting, by the one or more processors, the additional search results to the GUI.

10. A method comprising:
receiving, by one or more processors, search parameters via inputs to a graphical user interface (GUI);
executing, by the one or more processors, a search of a document database based on the search parameters to identify a set of search results, each search result of the set of search results corresponding to a particular document of a plurality of documents associated with the document database;
outputting, by the one or more processors, the set of search results to the GUI, wherein the GUI comprises one or more selectable elements for viewing the documents corresponding to set of search results;
receiving, by the one or more processors, a first input corresponding to selection of a first selected element of the one or more selectable elements, the first selected element corresponding to a particular search result of the set of search results;
displaying, based on the first input, a document corresponding to the particular search result;
initiating, by the one or more processors, a second search based on a second input received during display of the document corresponding to the particular search result, wherein the second search comprises:
querying a metadata database to identify additional search results, the additional search results corresponding to other documents of the plurality of documents that identify a cited with relationship with respect to the document corresponding to the particular search result and an additional document of the plurality of documents; and
outputting, by the one or more processors, the additional search results to the GUI.

11. The method of claim 10, wherein the cited with relationship is determined for each document of the plurality of documents by:
detecting, by the one or more processors, legal citations within a given document of the plurality of documents;
determining, by the one or more processors, a proximity metric for the given document based on a set of proximity rules, the proximity metric associated with the legal citations within the given document; and
evaluating, by the one or more processors, the given document based on the proximity metric and a set of contextual rules.

12. The method of claim 11, wherein the set of contextual rules are configured to:
identify markers corresponding to the legal citations within each document of the plurality of documents;
determine a structure for each document of the plurality of documents, wherein the structure identifies an organization of structural elements within each document, wherein the structural elements include sections, paragraphs, sentences, or a combination thereof; or
a combination thereof.

13. The method of claim 12, wherein the markers comprise legal citation signals, and wherein the set of contextual rules is configured to classify the cited with relationship as supportive, comparative, or contradictory based on the markers.

14. The method of claim 10, further comprising:
generating, for a given additional search result of the additional search results, a summary of a portion of the document corresponding to the additional search result, the portion comprising a first legal citation corresponding to the particular search result and a second legal citation corresponding to the additional document, the first and second legal citations having a cited with relationship with respect to one another; and
outputting the summary to the GUI.

15. The method of claim 10, wherein the document database and the metadata database are updated daily.

16. The method of claim 10, further comprising:
receiving, by the one or more processors, a third input corresponding to selection of a third selected element of the one or more selectable elements, the third selectable element corresponding to a subset of the additional search results corresponding to documents of the plurality of documents having a particular cited with relationship with the document corresponding to the particular search result.

17. A method comprising:
receiving, by one or more processors, a plurality of documents, each document of the plurality of documents comprising legal citations;
detecting, by the one or more processors, legal citations within a given document of the plurality of documents;
analyzing, by the one or more processors, each of the plurality of documents to detect a subset of documents in the plurality of documents, the subset of documents detected based on the legal citations within the given document;
determining, by the one or more processors, a proximity metric for each document of the subset of documents based on a set of proximity rules, the proximity metric associated with the legal citations within the given document;
pruning, by the one or more processors, the subset of documents based on the proximity metrics and a set of contextual rules to produce a reduced set of documents, the reduced set of documents corresponding to a portion of the subset of documents in which the legal citations have a cited with relationship;
generating, by the one or more processors, one or more records in a metadata database, wherein each of the one or more records comprises metadata that identifies at least one document within the reduced set of documents and the legal citations having the cited with relationship within the at least one document;
receiving, by the one or more processors, search parameters via inputs to a graphical user interface (GUI);
executing, by the one or more processors, a first search of a document database based on the search parameters to identify a set of search results, each search result of the set of search results corresponding to a particular document of a second plurality of documents associated with the document database;
outputting, by the one or more processors, the set of search results to the GUI, wherein the GUI comprises one or more selectable elements for viewing the documents corresponding to the set of search results;
receiving, by the one or more processors, a first input corresponding to selection of a selected element of the one or more selectable elements, the selected element corresponding to a particular search result of the set of search results;
displaying, based on the first input, a document corresponding to the particular search result;
initiating, by the one or more processors, a second search based on a second input received during display of the document corresponding to the particular search result, wherein the second search comprises:
querying the metadata database to identify additional search results, the additional search results corresponding to other documents of the second plurality of documents that have a cited with relationship with respect to the document corresponding to the particular search result and an additional document of the second plurality of documents; and
outputting, by the one or more processors, the additional search results to the GUI.

18. The method of claim 17, wherein the set of proximity rules classifies each of the additional documents identified in the given document relative to one another as having at least one of a document proximity, a section proximity, a paragraph proximity, or a sentence proximity.

19. The method of claim 17, wherein the set of contextual rules are configured to:
identify markers corresponding to the legal citations within each document of the plurality of documents;
determine a structure for each document of the plurality of documents, wherein the structure identifies an organization of structural elements within each document, wherein the structural elements include sections, paragraphs, sentences, or a combination thereof; or
a combination thereof.

20. The method of claim 17, wherein the document database and the metadata database are updated daily.
